(19) United States
(12) Patent Application Publication
(10) Pub. No.: US 2005/0275510 A1
(43) Pub. Date: Dec. 15, 2005

(54) Vehicular anti-theft system capable of supplying images related to a vehicle status to an authorized driver

(76) Inventor: Shih-Hsiung Li, Taipei (TW)

Correspondence Address: DELLETT AND WALTERS, P. O. BOX 2786, PORTLAND, OR, 97208-2786, US

(21) Appl. No.: 10/865,692

(22) Filed: Jun. 10, 2004

(51) Int. Cl. B60R 25/10

(52) U.S. Cl. 340/426.1; 340/937

(57) ABSTRACT

A vehicular anti-theft system provides a control device as well as multiple cameras mounted inside or outside the vehicle to capture plural images of the vehicle status when an abnormal situation occurs. These captured images are further transmitted to the authorized driver's mobile phone. Therefore, upon receiving of the images, the authorized driver can see who is driving and tracks where the vehicle is. After the confirming that the vehicle was stolen, these images sent to the mobile phone can be further supplied to the police as the important evidence when searching for the lost vehicle.

### BACKGROUND OF THE INVENTION

1. Field of the Invention

The present invention relates to a vehicular anti-theft system capable of supplying images of a vehicle status to an authorized driver, and more particularly to an anti-theft apparatus which supplies images showing inside/outside statuses of the vehicle to an authorized driver when an alarming signal is activated.

2. Description of Related Art

The vehicular anti-theft device has become almost standard equipment for most cars. As people know, the present vehicular anti-theft device usually is automatically activated to issue a warning sign in the form of lights or sounds while someone is attempting to steal the car thus frightening the thief away. However, once the car is unlawfully driven away, the vehicular anti-theft device has no use any more and is unable to supply any helpful information to assist the authorized driver to search for the car.

Therefore, a novel vehicular anti-theft system capable of supplying images of a vehicle status in accordance with the present invention is proposed to overcome the aforementioned drawback.

### SUMMARY OF THE INVENTION

The objective of the present invention is to provide a vehicular anti-theft system which supplies images showing a vehicle status to an authorized driver, whereby the authorized driver can determine whether someone is stealing the vehicle based on the received images.

To accomplish the foregoing objective, the vehicular anti-theft system comprises:

a plurality of cameras mounted at positions inside or outside a vehicle to capture images showing a status near a driver's seat and outside surroundings of the vehicle;

a control device coupled to the plurality of cameras, wherein the control device comprises:

a control unit coupled with a sensor that detects whether an abnormal situation occurs with the vehicle and coupled with an alarming unit that is capable of issuing an alarming signal;

a video signal switching unit coupled to the plurality of cameras and controlled by the control unit, wherein the video signal switching unit selects one image to be output from the plurality of cameras; and

an image transmitting unit coupled to the video signal switching unit and the control unit, wherein based on the control commands of the control unit, the image transmitting unit dials a number of a remote mobile phone and sending the image to the remote mobile phone.

Other objects, advantages, and unique features of the invention will become more apparent from the following detailed description and accompanying drawings.

### BRIEF DESCRIPTION OF THE DRAWINGS

FIG. 1 is an operational view showing an anti-theft apparatus in accordance with the present invention is applied to a vehicle;

FIG. 2 is another operational view showing the anti-theft apparatus in accordance with the present invention is applied to the vehicle;

FIG. 3 is yet another operational view showing the anti-theft apparatus in accordance with the present invention is applied to the vehicle;

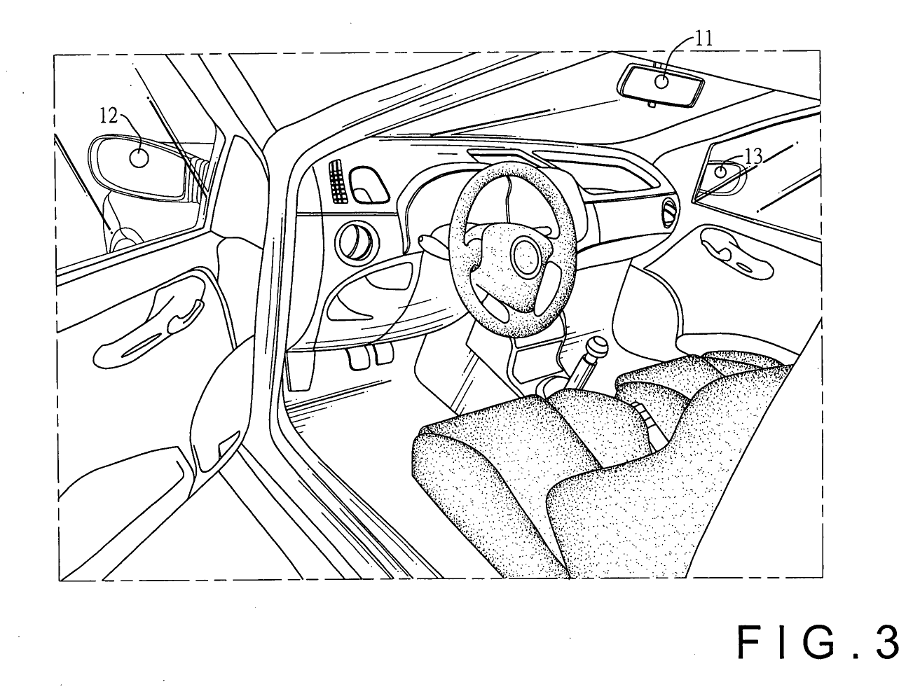

FIG. 4 is a circuit block diagram of the anti-theft apparatus according to a preferred embodiment of the present invention; and

FIG. 5 is a circuit block diagram of the anti-theft apparatus according to another preferred embodiment of the present invention.

### DETAILED DESCRIPTION OF THE PREFERRED EMBODIMENT

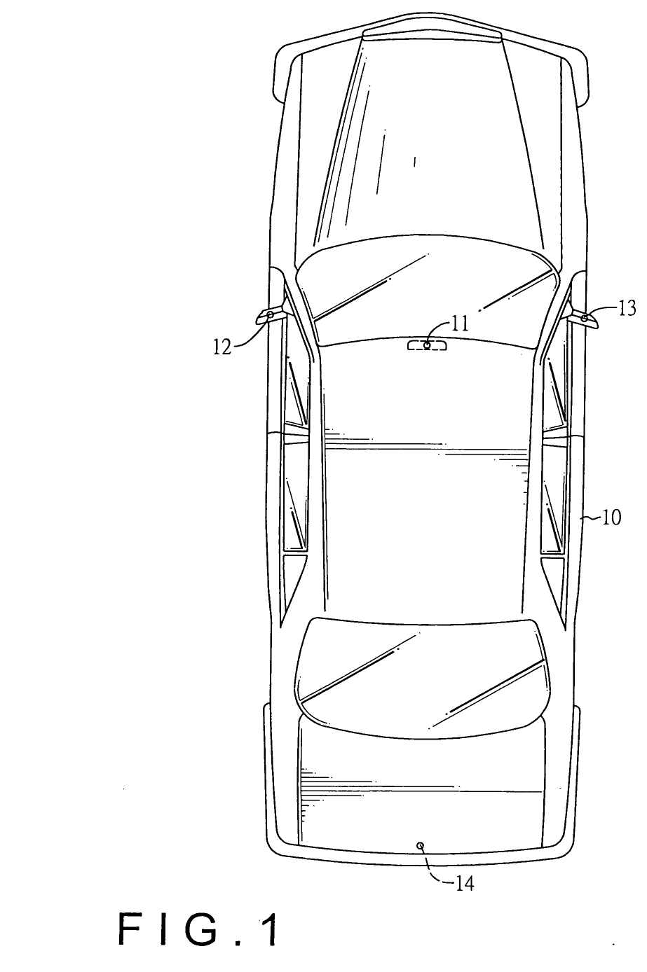

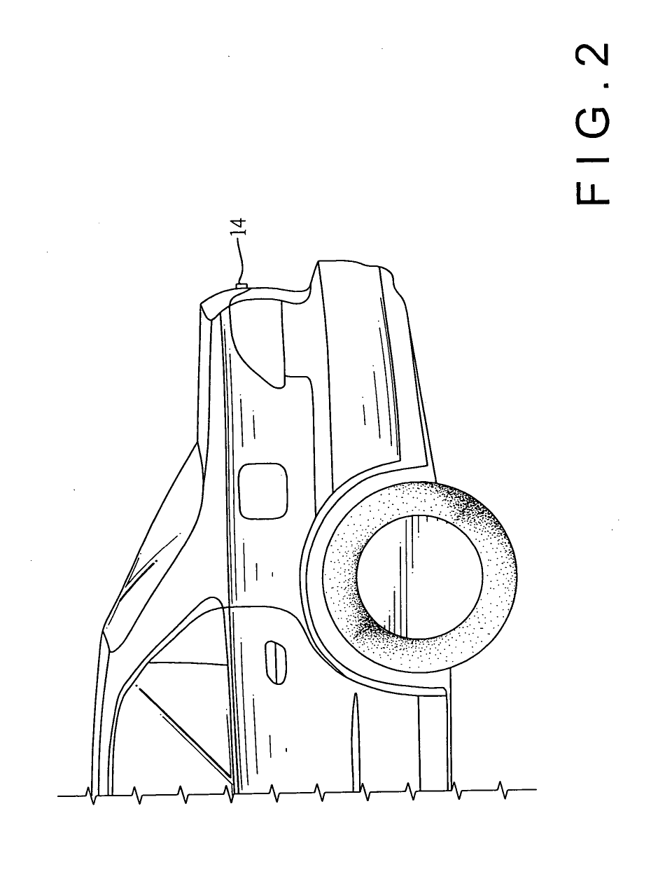

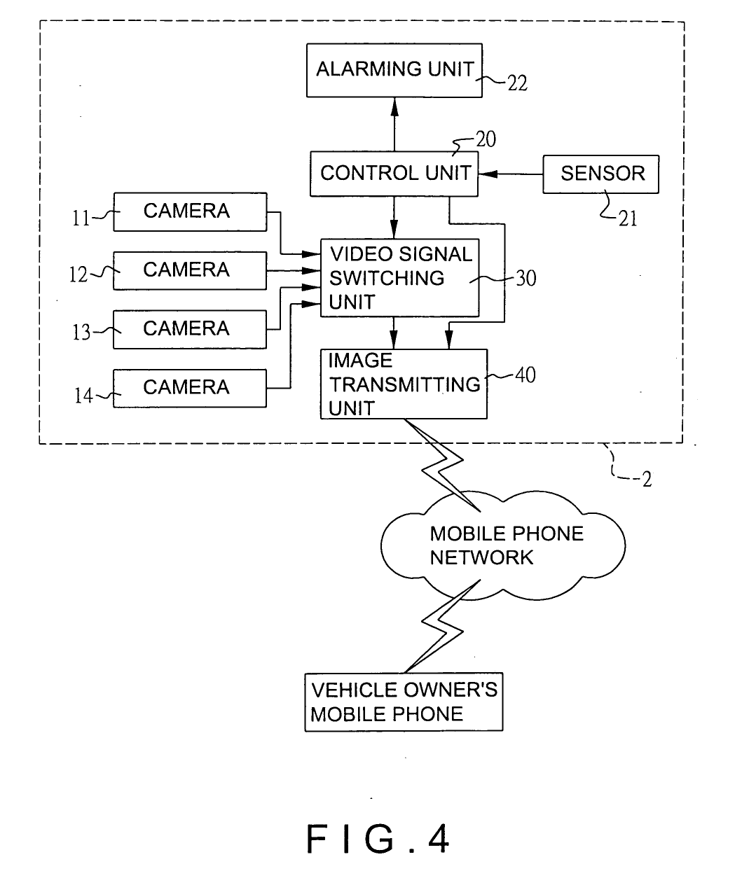

With reference to FIGS. 1 and 4, an anti-theft system in accordance with the 10 present invention mainly comprises a control device (2) and a plurality of cameras (11, 12, 13 and 14) coupled to a control unit (20). The plurality of cameras (11-14) can be installed at any desired positions inside or outside the vehicle (10). For example, the camera (11) is mounted at the place near the driver's seat to capture an image showing who is driving. The two cameras (12, 13) are preferably and respectively mounted at the left and right side-view mirrors to capture images of the surroundings. Further referring to FIG. 2, another camera (14) is mounted at a rear portion of the vehicle (10) to take photos of scenes behind the vehicle (10). The rear camera (14) may be any image capturing device already installed in the vehicle (10), such as a vehicle reversing radar capable of taking pictures.

With reference in FIG. 2, in more detail, the camera (11) inside the vehicle (10) is preferably mounted at the position near the rear-view mirror and toward the driver's seat.

With reference to FIG. 2, the control device (2) coupled to the plurality of the cameras (11-14) comprises a control unit (20), a sensor (21), an alarming unit (22), a video signal switching unit (30) and an image transmitting unit (40).

The control unit (20) is preferably a microprocessor with an input terminal connecting to the sensor (21). The sensor (21) can be a vibration sensor, an ultrasonic sensor, an infrared sensor or other types for anti-theft monitoring. The alarming unit (22) coupled to the control unit (20) is able to issue either a light alarming signal or a sound alarming signal, or both.

The video signal switching unit (30), preferably a multiplexer, has plural input terminals respectively coupled to the plurality of cameras (11-14). The video signal switching unit (30) is controlled by the control unit (20) to select a video signal among the cameras (11-14).

The image transmitting unit (40) is coupled to the video signal switching unit (30) and the control unit (20). Based on the control commands of the control unit (20), the image transmitting unit (40) automatically dials the authorized driver's mobile phone number and transmits the selected video signal to the called phone. Before the sending video signal, the image transmitting unit (40) converts the video signal to become a picture format that the mobile phone accepts.

The detailed operation of the invention is explained hereinafter. When the sensor (21) detects an abnormal situation, for example someone is attempting to steal the car, the control unit (20) simultaneously activates the alarming unit (22) to issue warning signals and activates the cameras (11-14) to take pictures. The captured pictures from the cameras (11-14) are sequentially selected by the video signal switching unit (30) and output to the image transmitting unit (40). The image transmitting unit (40) then dials the phone number and transmits the captured images over a mobile phone network to the authorized driver. Upon receiving the images, the authorized driver can see who is driving and track where the car is. After the confirming that the vehicle was stolen, these images stored in the mobile phone can be further supplied to the police as the important evidence when searching for the missing car.

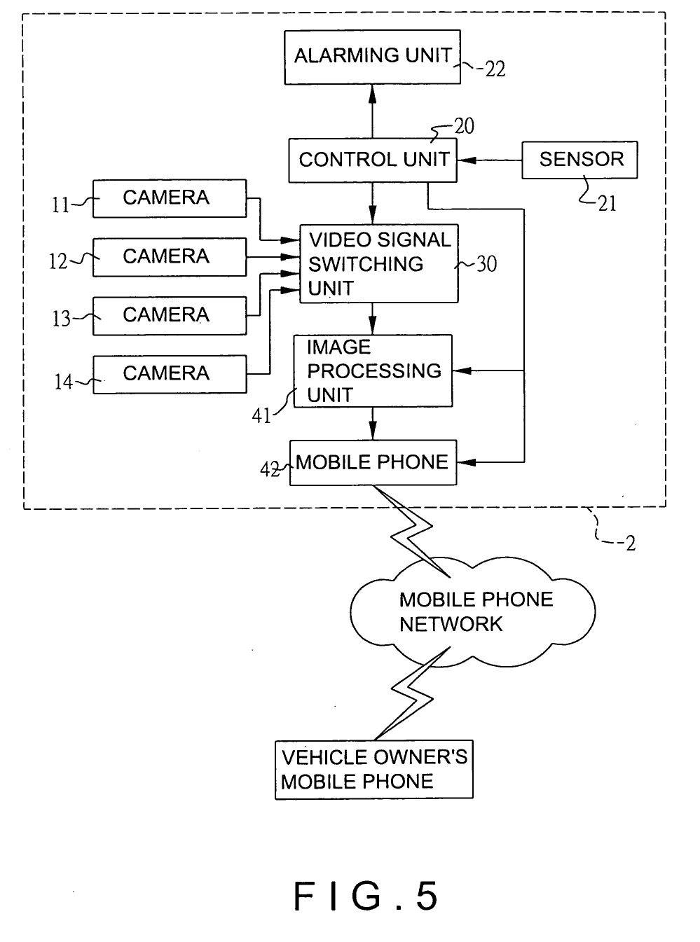

With reference to FIG. 5, the second embodiment of the control device (2) is substantially the same as the previous one, wherein the image transmitting unit (40) is formed by an image processing unit (41) and a mobile phone (42). The image processing unit (41) is provided to convert the image data output from the video signal switching unit (30) to fit a format that the mobile phone (42) can accept. The mobile phone (42) then dials a destination phone number and sends the images to that phone.

It is to be understood, however, that even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A vehicular anti-theft system capable of supplying images showing a vehicle status, the system comprising:
a plurality of cameras mounted at positions inside or outside a vehicle to capture images showing a status near a driver's seat and outside surroundings of the vehicle;
a control device coupled to the plurality of cameras, wherein the control device comprises:
a control unit coupled with a sensor that detects whether an abnormal situation occurs with the vehicle and coupled with an alarming unit that is capable of issuing an alarming signal;
a video signal switching unit coupled to the plurality of cameras and controlled by the control unit, wherein the video signal switching unit selects one image to be output from the plurality of cameras; and
an image transmitting unit coupled to the video signal switching unit and the control unit, wherein based on the control commands of the control unit, the image transmitting unit dials a number of a remote mobile phone and sends the image to the remote mobile phone.

2. The vehicular anti-theft system as claimed in claim 1, wherein the control unit is a microprocessor.

3. The vehicular anti-theft system as claimed in claim 1, wherein the image transmitting unit is composed of an image processing unit and a mobile phone.

4. The vehicular anti-theft system as claimed in claim 3, wherein the image transmitting unit is composed of an image processing unit and a mobile phone.

5. The vehicular anti-theft system as claimed in claim 1, wherein the image the sensor is a vibration sensor, an ultrasonic sensor or an infrared sensor.

6. The vehicular anti-theft system as claimed in claim 2, wherein the image the sensor is a vibration sensor, an ultrasonic sensor or an infrared sensor.

7. The vehicular anti-theft system as claimed in claim 3, wherein the image the sensor is a vibration sensor, an ultrasonic sensor or an infrared sensor.

8. The vehicular anti-theft system as claimed in claim 4, wherein the image the sensor is a vibration sensor, an ultrasonic sensor or an infrared sensor.

9. The vehicular anti-theft system as claimed in claim 8, wherein the cameras are respectively mounted at positions near a rear-view mirror, a side-view mirror and a rear portion of the vehicle.
